(19) United States
(12) Patent Application Publication
(10) Pub. No.: US 2022/0302498 A1
(43) Pub. Date: Sep. 22, 2022

(54) SOLID-STATE BATTERY

(71) Applicant: Murata Manufacturing Co., Ltd., Nagaokakyo-shi (JP)

(72) Inventor: Yosuke TOMOSHIGE, Nagaokakyo-shi (JP)

(21) Appl. No.: 17/834,166

(22) Filed: Jun. 7, 2022

Related U.S. Application Data
(63) Continuation of application No. PCT/JP2020/046116, filed on Dec. 10, 2020.

(30) Foreign Application Priority Data
Dec. 11, 2019 (JP) 2019-223852

(51) Int. Cl. H01M 10/0562; H01M 10/0585; H01M 10/0525; H01M 4/04; H01M 50/543; H01M 4/38

(52) U.S. Cl. CPC H01M 10/0562; H01M 10/0585; H01M 10/0525; H01M 4/0471; H01M 50/543; H01M 4/38

(57) ABSTRACT

A solid-state battery including a solid-state battery laminate having a positive electrode layer, a negative electrode layer, and a solid electrolyte layer interposed between the positive electrode layer and the negative electrode layer; and a positive electrode external terminal connected to the positive electrode layer and a negative electrode external terminal connected to the negative electrode layer are on a same surface of the solid-state battery laminate.

### CROSS REFERENCE TO RELATED APPLICATIONS

The present application is a continuation of International application No. PCT/JP2020/046116, filed Dec. 10, 2020, which claims priority to Japanese Patent Application No. 2019-223852, filed Dec. 11, 2019, the entire contents of each of which are incorporated herein by reference.

### FIELD OF THE INVENTION

The present invention relates to a solid-state battery. More specifically, the present invention relates to a layered solid-state battery constructed by stacking respective layers constituting battery constituent units.

### BACKGROUND OF THE INVENTION

Hitherto, secondary batteries that can be repeatedly charged and discharged have been used for various purposes. For example, secondary batteries are used as power sources of electronic devices such as smartphones and notebooks.

In secondary batteries, a liquid electrolyte is generally used as a medium for ion transfer contributing to charging and discharging. That is, a so-called electrolytic solution is used for secondary batteries. However, such secondary batteries are generally required to have safety in terms of leakage prevention of an electrolytic solution. Since an organic solvent or the like used in an electrolytic solution is a combustible substance, safety is required also in that respect.

Therefore, solid-state batteries using a solid electrolyte instead of an electrolytic solution have been studied.
Patent Document 1: Japanese Patent Application Laid-Open No. 2009-181905
Patent Document 2: Japanese Patent Application Laid-Open No. 2017-183052
Patent Document 3: Japanese Patent Application Laid-Open No. 2011-198692
Patent Document 4: WO 2008/099508 A

### SUMMARY OF THE INVENTION

A solid-state battery includes a solid-state battery laminate including a positive electrode layer, a negative electrode layer, and a solid electrolyte layer between the positive electrode layer and the negative electrode layer (see Patent Documents 1 to 4 above). More specifically, the positive electrode layer and the negative electrode layer are laminated with the solid electrolyte layer interposed therebetween. While a positive electrode active material is contained in the positive electrode layer, a negative electrode active material is contained in the negative electrode layer, and these materials are involved in accepting and donating electrons in the solid-state battery. That is, ions move between the positive electrode layer and the negative electrode layer through the solid electrolyte to charge and discharge the solid-state battery. In such a solid-state battery, external terminals 400 such as a positive electrode terminal and a negative electrode terminal face each other with the laminate interposed therebetween (see FIG. 12).

The inventors of the present application have noticed that there is still a problem to be overcome in view of actual use of the solid-state battery and have found a need to take measures therefor. Specifically, the inventors of the present application have found that there are the following problems.

In various battery applications including various devices, the solid-state battery can be housed in a housing space such as a casing and used. That is, it is assumed that the solid-state battery is installed to occupy a limited battery housing space. There is a possibility that the conventional external terminal arrangement of the solid-state battery cannot sufficiently cope with such a case, depending on restrictions of the type of the device, the design thereof, the battery housing space, and the like. That is, in the conventional arrangement of the positive electrode external terminal and the negative electrode external terminal in which the external terminals face each other with the solid-state battery laminate interposed therebetween, it may not possible to cope with installation of the solid-state battery in a limited battery housing space.

The solid-state battery may be mounted on various substrates such as a printed wiring board or a motherboard and used. For example, it is assumed to use the solid-state battery as an SMD type battery to be subjected to “surface mounting”. The surface-mounted solid-state battery may expand due to charging and discharging and/or thermal expansion, and the like and may undesirably come into contact with the substrate, which may cause a failure in the mounting substrate.

The present invention has been made in view of such problems. That is, a main object of the present invention is to provide a solid-state battery more suitable not only in terms of use in a battery housing space but also in terms of use in surface mounting.

The inventors of the present application have made an attempt to solve the above problems not by follow-on approach to the prior art but new direction approach. As a result, the inventors have reached the invention of a solid-state battery in which the above main object has been achieved.

In the present invention, there is provided a solid-state battery including: a solid-state battery laminate having a positive electrode layer, a negative electrode layer, and a solid electrolyte layer interposed between the positive electrode layer and the negative electrode layer; a positive electrode external terminal connected to the positive electrode layer; and a negative electrode external terminal connected to the negative electrode layer, in which both of the positive electrode external terminal and the negative electrode external terminal are on a same surface of the solid-state battery laminate.

A solid-state battery according to the present invention is more suitable not only in terms of use in a battery housing space but also in terms of use in surface mounting.

More specifically, in the solid-state battery of the present invention, both the positive electrode external terminal and the negative electrode external terminal are positioned on the same surface of the solid-state battery laminate, and the solid-state battery can be used in a battery housing space that is difficult to cope with in a conventional solid-state battery. When the battery is mounted on the substrate using the “same surface” as described above as the mounting-side surface, expansion due to charging and discharging and/or thermal expansion, and the like occurs in the facing direction between the solid-state battery and the substrate. Therefore, in the present invention, a disadvantageous phenomenon that the solid-state battery comes into contact with the substrate due to expansion may be avoided.

### BRIEF EXPLANATION OF THE DRAWINGS

FIG. 1 is a schematic perspective view for describing features of a solid-state battery according to an embodiment of the present invention.

FIG. 2 is a schematic side view for describing features of the solid-state battery according to the embodiment of the present invention.

FIG. 3 is a schematic plan view for describing features of the solid-state battery according to the embodiment of the present invention.

FIG. 4 is a schematic perspective view for describing the solid-state battery to be surface-mounted.

FIG. 5 is a schematic perspective view for describing a non-active material region.

FIGS. 6(a) to 6(f) are schematic plan views for describing various forms of a positive electrode active material region in plan view.

FIGS. 7(a) to 7(f) are schematic plan views for describing various forms of a negative electrode active material region in plan view.

FIG. 8A is a schematic plan view for describing that the negative electrode active material region is provided to extend to a contour corresponding to three non-negative electrode narrowed sides.

FIG. 8B is a schematic plan view for describing that the negative electrode active material region is provided to extend to a contour corresponding to three non-negative electrode narrowed sides.

FIG. 9 is a schematic plan view for describing “Embodiment Regarding Width Dimensional Relation between Electrode Narrowed Portions”.

FIG. 10 is a schematic plan view for describing a preferred feature with a narrowed portion when a current collecting layer is provided with respect to an electrode layer.

FIG. 11 is a schematic plan view for describing a preferred feature with a contour corner of a narrowed portion.

FIG. 12 is a schematic sectional view for describing a basic configuration of the solid-state battery.

### DETAILED DESCRIPTION OF THE INVENTION

Hereinafter, a solid-state battery of the present invention will be described in detail. Although the description will be given with reference to the drawings as necessary, the illustrated contents are only schematically and exemplarily illustrated to facilitate understanding of the present invention, and appearance and/or dimensional ratio, and the like may be different from actual ones.

The term “plan view” described herein is based on a form in a case where an object is captured from the upper side or the lower side along a thickness direction corresponding to a lamination direction of respective layers constituting a solid-state battery (particularly, a solid-state battery laminate). The term “sectional view” described herein is based on a form in which the object is captured from a direction substantially perpendicular to the lamination direction of respective layers constituting the solid-state battery (particularly, the solid-state battery laminate). In short, the term “sectional view” is based on a form obtained in a case where the object is captured by being cut with a plane parallel to the thickness direction. The terms “vertical direction” and “horizontal direction” directly or indirectly used herein correspond to the vertical direction and the horizontal direction in the drawings, respectively. Unless otherwise specified, the same reference numerals or symbols denote the same members or parts or the same semantic contents. In a preferred embodiment, it can be understood that the downward direction in the vertical direction (that is, a direction in which gravity acts) corresponds to the “downward direction”/“bottom surface side”, and the opposite direction corresponds to the “upward direction”/“top surface side”.

The term “solid-state battery” described in the present invention refers to a battery whose constituent elements are configured from a solid in a broad sense, and refers to an all-solid-state battery whose constituent elements (particularly preferably all constituent elements) are configured from a solid in a narrow sense. In a preferred embodiment, the solid-state battery in the present invention is a layered solid-state battery configured such that respective layers constituting battery constituent units are laminated with each other, and such respective layers are preferably made of a sintered body. The “solid-state battery” includes not only a so-called “secondary battery” capable of repeatedly being charged and discharged, but also a “primary battery” capable of only being discharged. According to a preferred embodiment of the present invention, the “solid-state battery” is a secondary battery. The “secondary battery” is not excessively limited by its name, and may include, for example, an electrochemical device such as a power storage device.

Hereinafter, first, a basic configuration of a solid-state battery that is considered to be necessary for understanding the present invention will be described. The configuration of the solid-state battery described herein is merely an example for describing a matter that is a premise of the solid-state battery, and does not limit the invention.

[Basic Configuration of Solid-State Battery]

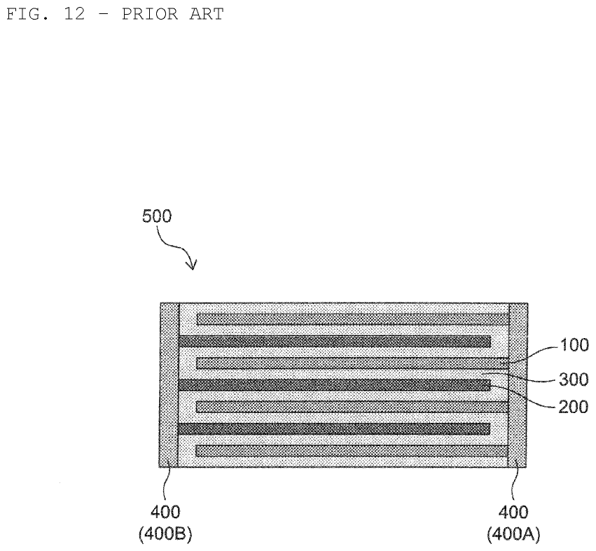

The solid-state battery includes at least electrode layers of a positive electrode and a negative electrode and a solid electrolyte layer. Specifically, as illustrated in FIG. 12, a solid-state battery has a solid-state battery laminate 500 which includes battery constituent units including a positive electrode layer 100, a negative electrode layer 200, and a solid electrolyte layer 300 interposed at least between the positive electrode layer and the negative electrode layer.

The solid-state battery is preferably formed by firing respective layers constituting the solid-state battery. The positive electrode layer, the negative electrode layer, the solid electrolyte layer, and the like form sintered layers. Preferably, the positive electrode layer, the negative electrode layer, and the solid electrolyte layer are fired integrally with each other, and thus, the solid-state battery laminate forms an integrally sintered body.

The positive electrode layer 100 is an electrode layer containing at least a positive electrode active material. The positive electrode layer may further contain a solid electrolyte. In a preferred embodiment, the positive electrode layer is configured from a sintered body containing at least positive electrode active material grains and solid electrolyte grains. On the other hand, the negative electrode layer is an electrode layer containing at least a negative electrode active material. The negative electrode layer may further contain a solid electrolyte. In a preferred embodiment, the negative electrode layer is configured from a sintered body containing at least negative electrode active material particles and solid electrolyte particles.

The positive electrode active material and the negative electrode active material are materials involved in accepting and donating electrons in the solid-state battery. Ions move (or conduct) between the positive electrode layer and the negative electrode layer through the solid electrolyte layer to accept and donate electrons, whereby charging and discharging are performed. Each of the positive electrode layer and the negative electrode layer is preferably a layer capable of occluding and releasing particularly lithium ions or sodium ions. That is, the solid-state battery is preferably an all-solid-state secondary battery in which lithium ions or sodium ions move between the positive electrode layer and the negative electrode layer through the solid electrolyte layer to charge and discharge the battery.

(Positive Electrode Active Material)

Examples of the positive electrode active material contained in the positive electrode layer include at least one selected from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like. Examples of the lithium-containing phosphate compound having a NASICON-type structure include Li₃V₂(PO₄)₃. Examples of the lithium-containing phosphate compound having an olivine-type structure include Li₃Fe₂(PO₄)₃, LiFePO₄, and LiMnPO₄. Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and LiNi_{0.5}Mn_{1.5}O₄.

Examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, a sodium-containing oxide having a spinel-type structure, and the like.

(Negative Electrode Active Material)

Examples of the negative electrode active material contained in the negative electrode layer 200 include at least one selected from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, lithium-containing oxide having a spinel-type structure, and the like. Examples of the lithium alloy include Li—Al. Examples of the lithium-containing phosphate compound having a NASICON-type structure include Li₃V₂(PO₄)₃ and LiTi₂(PO₄)₃. Examples of the lithium-containing phosphate compound having an olivine-type structure include Li₃Fe₂(PO₄)₃ and LiCuPO₄. Examples of the lithium-containing oxide having a spinel-type structure include Li₄Ti₅O₁₂.

Examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The positive electrode layer and/or the negative electrode layer may contain a conduction aid. Examples of the conduction aid contained in the positive electrode layer and the negative electrode layer may include at least one selected from the group consisting of metal materials such as silver, palladium, gold, platinum, aluminum, copper, and nickel, carbon, and the like. Although not particularly limited, copper is preferred in that copper is difficult to react with a positive electrode active material, a negative electrode active material, a solid electrolyte material, and the like and exhibits an effect of reducing the internal resistance of the solid-state battery.

The positive electrode layer and/or the negative electrode layer may further contain a sintering aid. Examples of the sintering aid may include at least one selected from the group consisting of lithium oxide, sodium oxide, potassium oxide, boron oxide, silicon oxide, bismuth oxide, and phosphorus oxide.

(Solid Electrolyte Layer)

The solid electrolyte layer 300 contains a material capable of conducting lithium ions or sodium ions. In particular, the solid electrolyte layer constituting the battery constituent unit in the solid-state battery is a layer capable of conducting lithium ions between the positive electrode layer and the negative electrode layer. Specific examples of materials for the solid electrolyte include a lithium-containing phosphate compound having a NASICON structure, an oxide having a perovskite structure, and an oxide having a garnet-type or pseudo-garnet-type structure. Examples of the lithium-containing phosphate compound having a NASICON structure include LiₓM_{y}(PO₄)₃ (1≤x≤2, 1≤y≤2, and M is at least one selected from the group consisting of Ti, Ge, Al, Ga, and Zr). Examples of the lithium-containing phosphate compound having a NASICON structure include Li_{1.2}Al_{0.2}Ti_{1.8}(PO₄)₃. Examples of the oxide having a perovskite structure include La_{0.55}Li_{0.35}TiO₃. Examples of the oxide having a garnet-type or pseudo-garnet-type structure include Li₇La₃Zr₂O₁₂.

Examples of materials for the solid electrolyte layer capable of conducting sodium ions include a sodium-containing phosphate compound having a NASICON structure, an oxide having a perovskite structure, and an oxide having a garnet-type or pseudo-garnet-type structure. Examples of the sodium-containing phosphate compound having a NASICON structure include NaₓM_{y}(PO₄)₃ (1≤x≤2, 1≤y≤2, and M is at least one selected from the group consisting of Ti, Ge, Al, Ga, and Zr).

The solid electrolyte layer may contain a sintering aid. The sintering aid contained in the solid electrolyte layer may be selected from, for example, the same materials as the sintering aid that may be contained in the positive electrode layer and/or the negative electrode layer.

(Positive Electrode Current Collecting Layer and Negative Electrode Current Collecting Layer)

Although not essential, the positive electrode layer 100 and the negative electrode layer 200 may include a positive electrode current collecting layer and a negative electrode current collecting layer, respectively. Each of the positive electrode current collecting layer and the negative electrode current collecting layer may have a foil form but preferably has a sintered body form (that is, a sintered layer form), focusing on the viewpoint of a reduction in manufacturing cost of the solid-state battery and a reduction in internal resistance of the solid-state battery due to integral firing. When the positive electrode current collecting layer and the negative electrode current collecting layer have a sintered body form, the positive electrode current collecting layer and the negative electrode current collecting layer may be configured by a sintered body containing a conductive material and a sintering aid. The conductive material contained in the positive electrode current collecting layer and the negative electrode current collecting layer may be selected from, for example, the same material as the conduction aid that may be contained in the positive electrode layer and the negative electrode layer. The sintering aid contained in the positive electrode current collecting layer and the negative electrode current collecting layer may be selected from, for example, the same materials as the sintering aid that may be contained in the positive electrode layer and/or the negative electrode layer. In the solid-state battery, the positive electrode current collecting layer and the negative electrode current collecting layer are not essential, and a solid-state battery in which such a positive electrode current collecting layer and/or negative electrode current collecting layer is not provided is also conceivable. That is, the solid-state battery in the present invention may be a solid-state battery without a current collecting layer.

(External Terminal)

The solid-state battery is generally provided with an external terminal. In particular, an external terminal 400 is provided on the side surface of the solid-state battery. FIG. 12 particularly illustrates an arrangement embodiment of a pair of external terminals (400A and 400B) arranged to face each other which is seen in the conventional configuration. More specifically, a positive electrode external terminal 400A connected to the positive electrode layer 100 and a negative electrode external terminal 400B connected to the negative electrode layer 200 are provided (see FIG. 12). Such external terminals preferably contain a material having high conductivity. A specific material for the external terminal is not particularly limited, but examples thereof may include at least one selected from the group consisting of silver, gold, platinum, aluminum, copper, tin, and nickel.

[Features of Solid-State Battery of Present Invention]

The solid-state battery of the present invention has a feature in arrangement of external terminals. In particular, the present invention has a feature in that external terminals are provided to have are form different from a conventional arrangement. In the conventional arrangement, the positive electrode external terminal and the negative electrode external terminal of the solid-state battery face each other with the solid-state battery laminate interposed therebetween, but the external terminals of the solid-state battery according to the present invention does not have such an arrangement form.

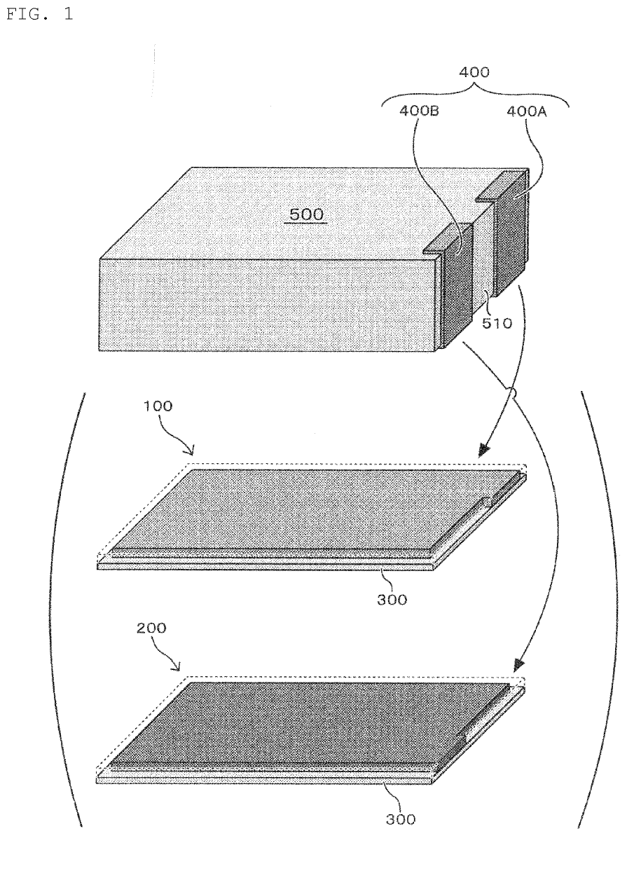

FIGS. 1 to 3 schematically illustrate features of the present invention. The solid-state battery of the present invention has a plurality of surfaces, and both of the positive electrode external terminal 400A connected to the positive electrode layer and the negative electrode external terminal 400B connected to the negative electrode layer are provided on the same surface of the solid-state battery laminate 500 (see, particularly, FIG. 1). In other words, the positive electrode external terminal 400A and the negative electrode external terminal 400B are not arranged to face each other with the solid-state battery laminate 500 interposed therebetween, but are arranged to be adjacent to each other on one surface of the solid-state battery laminate 500. The “plurality of surfaces” described herein refer to surfaces formed by the solid-state battery (more specifically, the solid-state battery laminate) in a broad sense. In a narrow sense, the “plurality of surfaces” refer to surfaces including a main surface and a side surface (for example, a planar and/or curved surface, and the like) in the solid-state battery (more specifically, the solid-state battery laminate).

Such a non-opposing arrangement of the positive electrode external terminal and the negative electrode external terminal brings about an advantageous effect for both installation and/or surface mounting applications in a battery housing space.

Specifically, the solid-state battery of the present invention in which the external terminals on both the positive electrode side and the negative electrode side are positioned on the same surface of the solid-state battery laminate may be suitable for a specific battery housing space. More specifically, in the present invention, the solid-state battery can be used in a battery housing space in which the positive electrode external terminal and the negative electrode external terminal are required to face the same direction. This means that, when the housing space for a conventional battery (for example, a conventional battery referred to as a so-called “LiB”), it may become easy to use a solid-state battery which is substituted for such a battery.

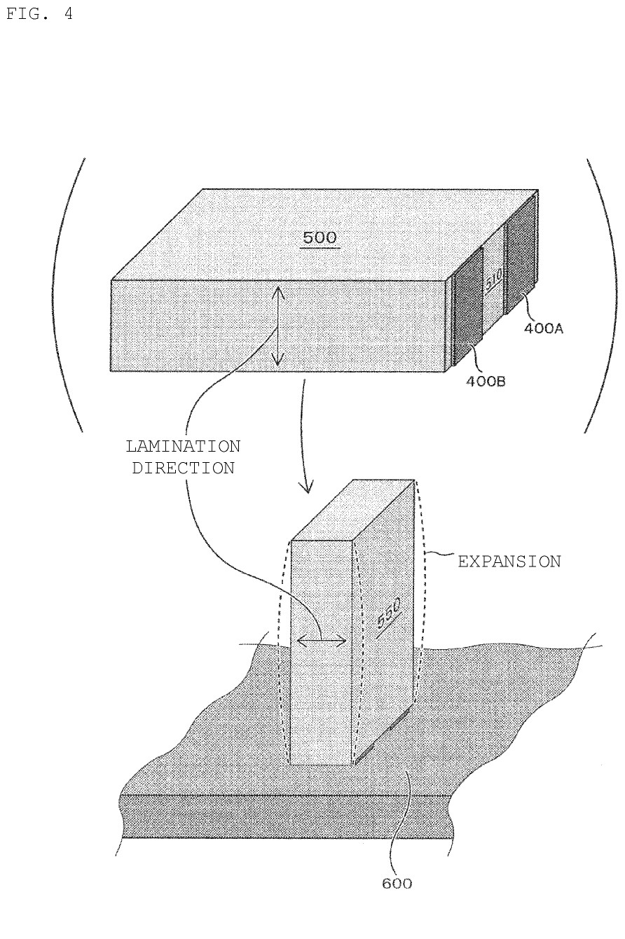

The solid-state battery of the present invention in which the external terminals on both the positive electrode side and the negative electrode side are positioned on the same surface of the solid-state battery laminate may be a battery more suitable for mounting on a substrate such as a printed wiring board or a motherboard. In particular, when a battery is surface-mounted with the “same surface” on which the external terminals are provided as the mounting-side surface, adverse influences attributable to expansion and contraction of the solid-state battery may be avoided. When the solid-state battery mounted on the substrate is expanded due to charging and discharging and/or thermal expansion, and the like, the solid-state battery may come into contact with or collide with the substrate; however, in the present invention, such a disadvantageous phenomenon may be avoided. The reason for this is that, when a battery is mounted with the “same surface” on which both the external terminals are provided as the mounting-side surface, expansion occurs in a direction orthogonal to a direction in which the solid-state battery (particularly, the solid-state battery laminate 500) and a substrate 600 face each other (see FIG. 4).

The solid-state battery in which the external terminals on both the positive electrode side and the negative electrode side are positioned on the same surface of the solid-state battery laminate may also exhibit an effect of suppressing generation of cracks. In particular, although cracks and the like may be generated in the solid-state battery due to expansion attributable to charging and discharging of the battery and/or thermal expansion, and the like and contraction attributable thereto, such physical defects may be suppressed in the present invention. This will be described in detail. In the conventional typical external terminal arrangement, as described above, the positive electrode external terminal 400A and the negative electrode external terminal 400B face each other with the solid-state battery laminate interposed therebetween (see FIG. 12). In this face-type external terminal arrangement, since both sides of the solid-state battery laminate are constrained by the facing external terminals, the internal stress due to expansion and contraction of the solid-state battery tends to be gradually accumulated. Therefore, in the conventional face-type external terminal arrangement, cracks are likely to be generated in the solid-state battery due to the internal stress accumulated in this way. On the other hand, in the present invention, since the external terminals on both the positive electrode side and the negative electrode side are positioned on the same surface of the solid-state battery laminate, the positive electrode external terminal and the negative electrode external terminal are arranged not to face each other without the solid-state battery laminate interposed therebetween, and an undesirable internal stress caused by expansion and contraction of the solid-state battery is hardly accumulated. In short, surfaces other than the “same surface” are not constrained by the external terminal in the solid-state battery of the present invention, and therefore, the internal stress generated due to expansion and contraction of the solid-state battery is easily released. For this reason, the solid-state battery of the present invention in which the external terminals on both the positive electrode side and the negative electrode side are positioned on the same surface of the solid-state battery laminate can suppress generation of cracks due to expansion and contraction of the solid-state battery. The term “constrain(ed)” described herein substantially means that expansion and contraction of the solid-state battery is inhibited or suppressed by the external terminals provided on the side surface of the solid-state battery laminate. In other words, in such an embodiment, expansion and/or contraction of the solid-state battery laminate due to charging and discharging and/or thermal expansion, and the like is not suppressed in surfaces (particularly, the side surface) other than the “same surface” of the solid-state battery laminate from the outside (that is, such expansion and contraction are suppressed only on the “same surface” among the plurality of surfaces of the solid-state battery laminate).

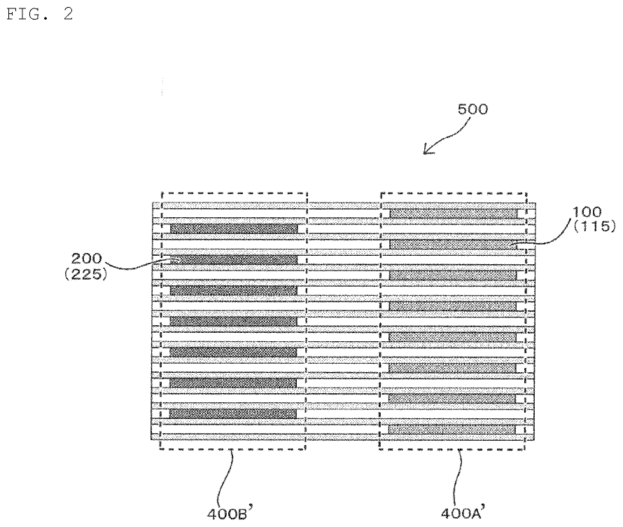

In a preferred embodiment, the positive electrode external terminal and the negative electrode external terminal are arranged side by side with each other. That is, as illustrated in FIGS. 1 and 2, the positive electrode external terminal 400A and the negative electrode external terminal 400B provided on the same surface of the solid-state battery laminate 500 are spaced apart from each other, but may be arranged proximally to each other. For example, the positive electrode external terminal 400A and the negative electrode external terminal 400B are provided to be adjacent to or lie next to each other such that the external terminals are provided across an intermediate line dividing the same surface into half (particularly, an intermediate line extending in the lamination direction) and sandwich the intermediate line. As can be seen from the embodiment illustrated in the drawing, the positive electrode external terminal and the negative electrode external terminal according to this embodiment may be provided to seem to be compatible with each other in terms of appearance form. Preferably, the positive electrode external terminal and the negative electrode external terminal are arranged to extend in the same or similar direction in the same surface of the solid-state battery laminate. For example, the positive electrode external terminal and the negative electrode external terminal may extend to have a parallel relation or a juxtapositional relation with each other (preferably extend in a direction along the lamination direction) on the same surface. As illustrated in FIGS. 1 and 2, the positive electrode external terminal and the negative electrode external terminal may be provided to extend in a direction along the lamination direction of the solid-state battery laminate (preferably extend in the same direction as the lamination direction) in the same surface of the solid-state battery laminate. The positive electrode external terminal and the negative electrode external terminal may have the same or similar width dimension (dimension in a direction orthogonal to an extension length) in the same or similar extension length (an extension length along the lamination direction) on the same surface.

Such a positive electrode external terminal and a negative electrode external terminal on the same surface contribute to compact external terminal arrangement as a whole, and thus may be suitable for a battery housing space in which the positive electrode external terminal and the negative electrode external terminal need to be on the same side. When a battery is surface-mounted with the “same surface” as the mounting-side surface, a solid-state battery can be mounted more accurately or more stably.

As can be seen from the embodiment illustrated in the upper view of FIG. 1, in the solid-state battery of the present invention, the solid-state battery laminate 500 has a rectangular parallelepiped as a whole. The term “rectangular parallelepiped” described herein is not limited to a complete rectangular parallelepiped, and may be widely interpreted including a three-dimensional shape of a substantially rectangular parallelepiped that is regarded as being changed on the basis of the complete rectangular parallelepiped. For example, the “rectangular parallelepiped” is not limited to a complete rectangular parallelepiped as a geometric configuration thereof, also includes a cube, and further includes a shape that can still be included in the concept of a rectangular parallelepiped or a cube also in a case where such a rectangular parallelepiped shape or a cube shape is sectionally missed or deformed, as roughly understood. For explanatory convenience, description will be made hereinafter while the “rectangular parallelepiped” is also referred to as the “substantially rectangular parallelepiped”.

When the solid-state battery laminate has such a substantially rectangular parallelepiped as a whole, the “same surface” may correspond to one side surface of the substantially rectangular parallelepiped. The term “side surface” described herein refers to a laminate surface existing in a direction orthogonal to the lamination direction in the solid-state battery laminate. That is, the same surface of the solid-state battery laminate on which the external terminals on both the positive electrode side and the negative electrode side are positioned may correspond to one selected from surfaces forming a substantially rectangular parallelepiped of the solid-state battery laminate (see the upper view of FIG. 1). Although being merely an example, the external terminals on both the positive electrode side and the negative electrode side may be positioned with respect to a side surface having a relatively small area among surfaces of such a substantially rectangular parallelepiped. For example, the external terminals on both the positive electrode side and the negative electrode side may be positioned with respect to a side surface having an area smaller than a main surface having the largest area (in the solid-state battery laminate illustrated in FIG. 1, a surface forming an upper surface and/or a lower surface of the solid-state battery laminate) in the solid-state battery laminate.

The solid-state battery in which the solid-state battery laminate has a substantially rectangular parallelepiped as a whole and the “same surface” corresponds to one side surface of the substantially rectangular parallelepiped may be suitable for a battery housing space similarly having a substantially rectangular parallelepiped. In addition, it becomes easy to perform an operation and the like when the solid-state battery is surface-mounted with the “same surface” as the mounting-side surface. As for the solid-state battery laminate having a substantially rectangular parallelepiped, in the first place, the solid-state battery has a shape similar to the solid-state battery laminate, and thus, relatively stable installation, storage, or the like of the battery is also possible.

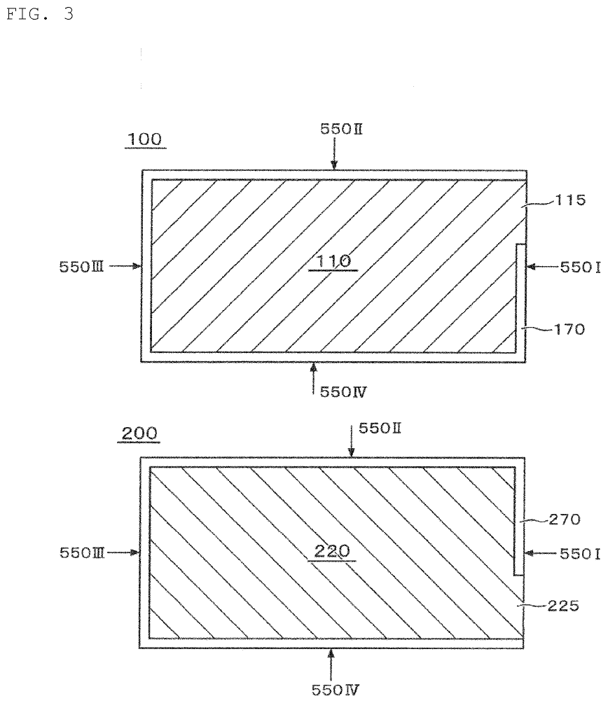

In a preferred embodiment, the electrode layer has a narrowed portion in the active material region. More specifically, the positive electrode layer preferably has a positive electrode narrowed portion in which a positive electrode active material region is narrowed toward “the same surface”. Similarly, the negative electrode layer preferably has a negative electrode narrowed portion in which a negative electrode active material region is narrowed toward “the same surface”. That is, as illustrated in FIG. 3, in a plan view of the positive electrode layer 100, a partial shape of the positive electrode active material region caused by sectionally narrowing the positive electrode active material region 110 corresponds to a positive electrode narrowed portion 115. Similarly, in a plan view of the negative electrode layer 200, a partial shape of the negative electrode active material region caused by sectionally narrowing the negative electrode active material region 220 corresponds to a negative electrode narrowed portion 225. As can be seen from the embodiment illustrated in the drawing, the positive electrode narrowed portion 115 and the negative electrode narrowed portion 225 are positioned so as not to face each other in the lamination direction (that is, when the positive electrode layer and the negative electrode layer are overlapped with each other in plan view, the positive electrode narrowed portion 115 and the negative electrode narrowed portion 225 do not overlap each other).

When such electrode narrowed portions are provided, the positive electrode external terminal is provided to be in contact with the positive electrode narrowed portion, and the negative electrode external terminal is provided to be in contact with the negative electrode narrowed portion. In particular, it is preferable that the internal surface of the positive electrode external terminal and the end surface of the positive electrode narrowed portion are in contact with each other, and similarly, it is preferable that the internal surface of the negative electrode external terminal and the end surface of the negative electrode narrowed portion are in contact with each other. In other words, the positive electrode external terminal and the negative electrode external terminal provided on the “same surface” are electrically connected to the end surfaces of the positive electrode narrowed portion and the negative electrode narrowed portion which may be exposed on the “same surface”, respectively.

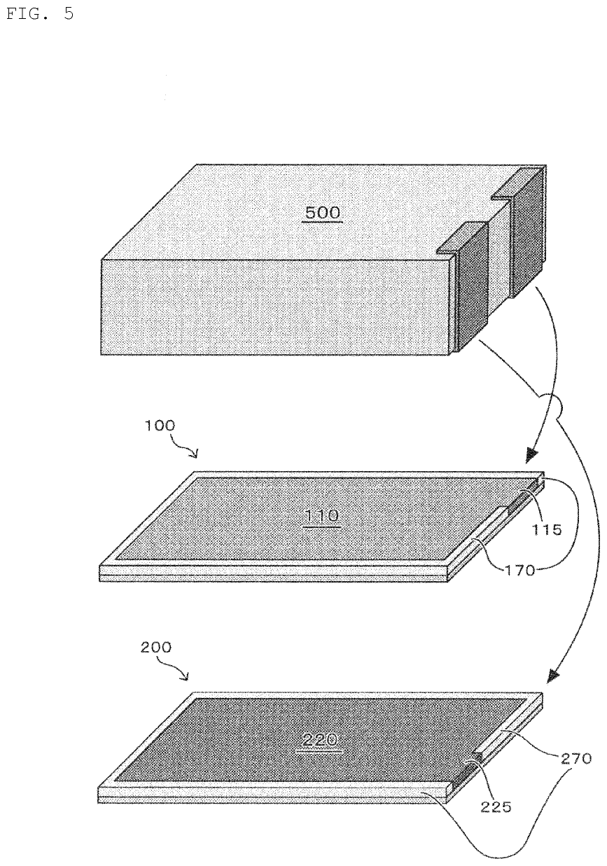

As illustrated in FIGS. 3 and 5, in the positive electrode layer 100, a peripheral edge portion 170 around the positive electrode narrowed portion 115 may be provided with a region (non-active material region) where the positive electrode active material is not provided. Similarly, in the negative electrode layer 200, a peripheral edge portion 270 around the negative electrode narrowed portion 225 may be provided with a region (non-active material region) where the negative electrode active material is not provided. Such a non-active material region is a region having an insulation property. More specifically, the non-active material region preferably has at least an electronic insulation property. As the material for the non-active material region, materials commonly used as a “non-active material” for the solid-state battery may be used, and for example, materials including a resin material, a glass material and/or a ceramic material, and the like may be used. As long as a desired electronic insulation property is secured, the non-active material region may additionally contain a solid electrolyte material as a material therefor. From the viewpoint of producing by means of firing, the non-active material region may have a sintered body form. Although being merely an example, examples of a material contained in the non-active material region may include at least one selected from the group consisting of soda lime glass, potassium glass, borate-based glass, borosilicate-based glass, barium borosilicate-based glass, bismuth zinc borate-based glass, bismuth silicate-based glass, phosphate-based glass, aluminophosphate-based glass, and zinc phosphate-based glass. The ceramic material contained in the non-active material region is not particularly limited, but examples thereof may include at least one selected from the group consisting of aluminum oxide, boron nitride, silicon dioxide, silicon nitride, zirconium oxide, aluminum nitride, silicon carbide, and barium titanate. The non-active material region can also be referred to as a “margin portion” or a “negative portion” because of its form. As can be seen from FIGS. 3 and 5, the non-active material region can also be referred to as a “margin portion” or a “negative portion” because of its form. For example, the width dimension of the non-active material region (the margin portion/the negative portion) in plan view may be about 0.2 mm to 0.8 mm, and is preferably about 0.3 mm to 0.6 mm.

The provision of the positive electrode narrowed portion and the negative electrode narrowed portion as described above suitably contributes to the arrangement of the positive electrode external terminal and the negative electrode external terminal on the same surface. This is because the positive electrode narrowed portion and the negative electrode narrowed portion do not face each other in the lamination direction in the battery laminate, and thus a short circuit between the positive electrode external terminal and the negative electrode external terminal can be suitably prevented also in the “arrangement on the same surface”.

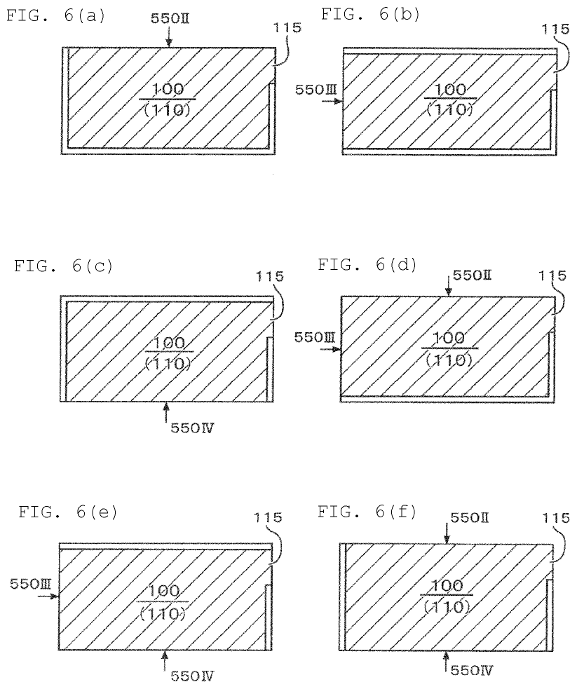

In a preferred embodiment, the positive electrode active material region is provided to extend to a plan-view contour of the solid-state battery laminate in at least one side other than a side on which the positive electrode narrowed portion is positioned among sides forming the plan-view contour. More specifically, the “side on which the positive electrode narrowed portion is positioned among sides forming the plan-view contour of the solid-state battery laminate” is a side indicated by reference numeral 550I in the upper view of the positive electrode layer 100 in plan view of FIG. 3. Sides other than the “side on which the positive electrode narrowed portion is positioned among sides forming the plan-view contour of the solid-state battery laminate” are sides indicated by reference numerals 550II, 550III, and 550IV. Therefore, such a preferred embodiment may have, for example, embodiments illustrated in FIGS. 6(a) to 6(f). As can be seen from the embodiments illustrated in the drawings, in at least one side other than a side on which the positive electrode narrowed portion 115 is positioned, the positive electrode active material region 110 is provided to extend to the outermost peripheral edge in the solid-state battery laminate. Therefore, the expression “to extend to the contour” means that the positive electrode active material region (that is, the positive electrode active material) exists up to the outer surface forming the solid-state battery laminate (particularly, the outer surface portion at the layer level where the positive electrode layer is positioned). In short, it can be said that the positive electrode active material is provided in a wider range up to a portion forming the plan-view contour of the solid-state battery laminate.

The details will be described in more detail. For explanatory convenience, the “side on which the positive electrode narrowed portion is positioned among sides forming the plan-view contour of the solid-state battery laminate” is referred to as a positive electrode narrowed side; meanwhile, the “sides different from the side on which the positive electrode narrowed portion is positioned among sides forming the plan-view contour of the solid-state battery laminate and corresponding to sides other than the side on which the positive electrode narrowed portion is positioned” is referred to as non-positive electrode narrowed sides. In FIG. 6(a), the positive electrode active material region is provided to extend to the contour (that is, the outermost peripheral edge) of the solid-state battery laminate in one of three non-positive electrode narrowed sides. In the embodiment illustrated in the drawing, the positive electrode active material region 110 is provided up to the contour of the solid-state battery laminate corresponding to the non-positive electrode narrowed side 550II. Also in FIG. 6(b), the positive electrode active material region is provided to extend to the contour of the solid-state battery laminate in one of three non-positive electrode narrowed sides. In the embodiment illustrated in the drawing, the positive electrode active material region 110 is provided up to the contour of the solid-state battery laminate corresponding to the non-positive electrode narrowed side 550III. Also in FIG. 6(c), the positive electrode active material region is provided to extend to the contour of the solid-state battery laminate in one of three non-positive electrode narrowed sides. In the embodiment illustrated in the drawing, the positive electrode active material region 110 is provided up to the contour of the solid-state battery laminate corresponding to the non-positive electrode narrowed side 550IV. In FIG. 6(d), the positive electrode active material region is provided to extend to the contour of the solid-state battery laminate in two of three non-positive electrode narrowed sides. In the embodiment illustrated in the drawing, the positive electrode active material region 110 is provided up to the contour of the solid-state battery laminate corresponding to the non-positive electrode narrowed sides 550II and 550III. Also in FIG. 6(e), the positive electrode active material region is provided to extend to the contour of the solid-state battery laminate in two of three non-positive electrode narrowed sides. In the embodiment illustrated in the drawing, the positive electrode active material region 110 is provided up to the contour of the solid-state battery laminate corresponding to the non-positive electrode narrowed sides 550III and 550IV. Also in FIG. 6(f), the positive electrode active material region is provided to extend to the contour of the solid-state battery laminate in two of three non-positive electrode narrowed sides. In the embodiment illustrated in the drawing, the positive electrode active material region 110 is provided up to the contour of the solid-state battery laminate corresponding to the non-positive electrode narrowed sides 550II and 550IV. As can be seen from the embodiments of FIGS. 6(a) to 6(f), in the non-positive electrode narrowed side, the positive electrode active material region 110 is not limited to being provided up to the contour of the solid-state battery laminate so as to extend to all portions, and the positive electrode active material region 110 may be provided with respect to the contour of the solid-state battery laminate so as to extend to at least a part of the side.

When the positive electrode active material region is provided to extend to the non-positive electrode narrowed side in this way, a battery capacity may increase. That is, the volume energy density of the solid-state battery can be suitably improved. According to the embodiments illustrated in FIG. 6, the battery capacity is more likely to be increased and thus the volume energy density is more likely to be improved in a case where the positive electrode active material region 110 is provided up to the contour corresponding to two non-positive electrode narrowed sides (FIGS. 6(d) to 6(f)) than in a case where the positive electrode active material region 110 is provided up to the contour corresponding to one non-positive electrode narrowed side (FIGS. 6(a) to 6(c)).

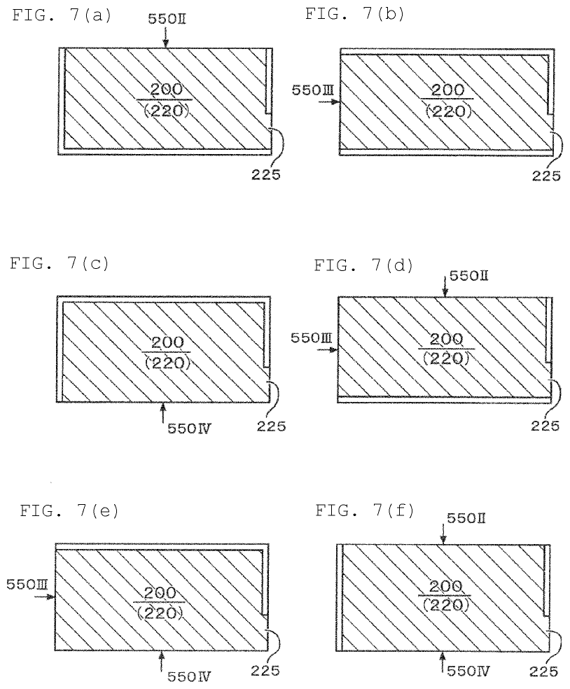

In a preferred embodiment, the negative electrode active material region is provided to extend to a contour of the solid-state battery laminate in at least one side other than a side on which the negative electrode narrowed portion is positioned among sides forming the plan-view contour of the solid-state battery laminate. More specifically, the “side on which the negative electrode narrowed portion is positioned among sides forming the plan-view contour of the solid-state battery laminate” is a side indicated by reference numeral 550I in the lower view of the negative electrode layer 200 in plan view of FIG. 3. Sides other than the “side on which the negative electrode narrowed portion is positioned among sides forming the plan-view contour of the solid-state battery laminate” are sides indicated by reference numerals 550II, 550III, and 550IV. Therefore, such a preferred embodiment may have, for example, embodiments illustrated in FIGS. 7(a) to 7(f). As can be seen from the embodiments illustrated in the drawings, in at least one side other than a side on which the negative electrode narrowed portion is positioned, the negative electrode active material region is provided to extend to the outermost peripheral edge in the solid-state battery laminate. Therefore, the expression “to extend to the contour” means that the negative electrode active material region (that is, the negative electrode active material) exists up to the outer surface forming the solid-state battery laminate (particularly, the outer surface portion at the layer level where the negative electrode layer is positioned). In short, it can be said that the negative electrode active material is provided in a wider range up to a portion forming the plan-view contour of the solid-state battery laminate.

The details will be described in more detail. For explanatory convenience, the “side on which the negative electrode narrowed portion is positioned among sides forming the plan-view contour of the solid-state battery laminate” is referred to as a negative electrode narrowed side; meanwhile, the “sides different from the side on which the negative electrode narrowed portion is positioned among sides forming the plan-view contour of the solid-state battery laminate and corresponding to sides other than the side on which the negative electrode narrowed portion is positioned” is referred to as non-negative electrode narrowed sides. In FIG. 7(a), the negative electrode active material region is provided to extend to the contour (that is, the outermost peripheral edge) of the solid-state battery laminate in one of three non-negative electrode narrowed sides. In the embodiment illustrated in the drawing, the negative electrode active material region 220 is provided up to the contour of the solid-state battery laminate corresponding to the non-negative electrode narrowed side 550II. Also in FIG. 7(b), the negative electrode active material region is provided to extend to the contour of the solid-state battery laminate in one of three non-negative electrode narrowed sides. In the embodiment illustrated in the drawing, the negative electrode active material region 220 is provided up to the contour of the negative electrode layer corresponding to the non-negative electrode narrowed side 550III. Also in FIG. 7(c), the negative electrode active material region is provided to extend to the contour of the solid-state battery laminate in one of three non-negative electrode narrowed sides. In the embodiment illustrated in the drawing, the negative electrode active material region 220 is provided up to the contour of the solid-state battery laminate corresponding to the non-negative electrode narrowed side 550IV. In FIG. 7(d), the negative electrode active material region is provided to extend to the contour of the solid-state battery laminate in two of three non-negative electrode narrowed sides. In the embodiment illustrated in the drawing, the negative electrode active material region 220 is provided up to the contour of the solid-state battery laminate corresponding to the non-negative electrode narrowed sides 550II and 550III. Also in FIG. 7(e), the negative electrode active material region is provided to extend to the contour of the solid-state battery laminate in two of three non-negative electrode narrowed sides. In the embodiment illustrated in the drawing, the negative electrode active material region 220 is provided up to the contour of the solid-state battery laminate corresponding to the non-negative electrode narrowed sides 550III and 550IV. Also in FIG. 7(f), the negative electrode active material region is provided to extend to the contour of the solid-state battery laminate in two of three non-negative electrode narrowed sides. In the embodiment illustrated in the drawing, the negative electrode active material region 220 is provided up to the contour of the solid-state battery laminate corresponding to the non-negative electrode narrowed sides 550II and 550IV. As can be seen from the embodiments of FIGS. 7(a) to 7(f), in the non-negative electrode narrowed side, the negative electrode active material region 220 is not limited to being provided up to the contour of the solid-state battery laminate so as to extend to all portions, and the negative electrode active material region 220 may be provided up to the contour of the solid-state battery laminate so as to extend to at least a part of the side.

When the negative electrode active material region is provided to extend to the non-negative electrode narrowed side in this way, a battery capacity may increase. That is, the volume energy density of the solid-state battery can be suitably improved. According to the embodiments illustrated in FIG. 7, the battery capacity is more likely to be increased and thus the volume energy density is more likely to be improved in a case where the negative electrode active material region is provided up to the contour corresponding to two non-negative electrode narrowed sides (FIGS. 7(d) to 7(f)) than in a case where the negative electrode active material region is provided up to the contour corresponding to one non-negative electrode narrowed side (FIGS. 7(a) to 7(c)).

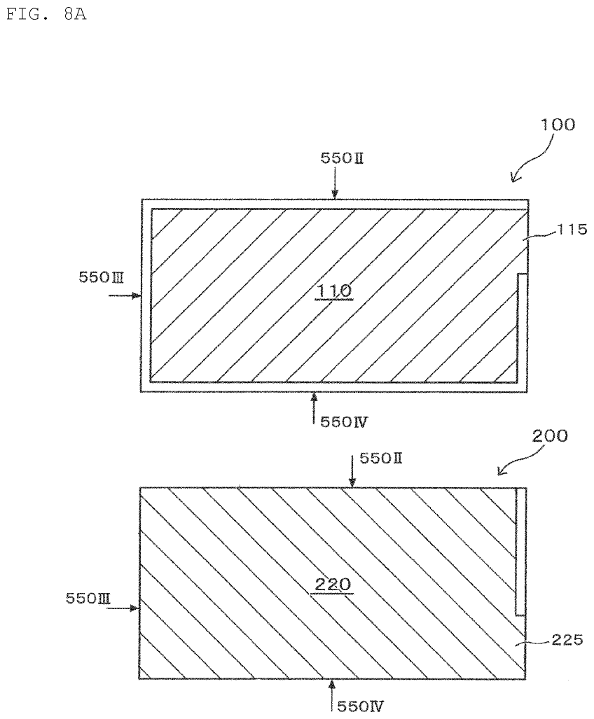

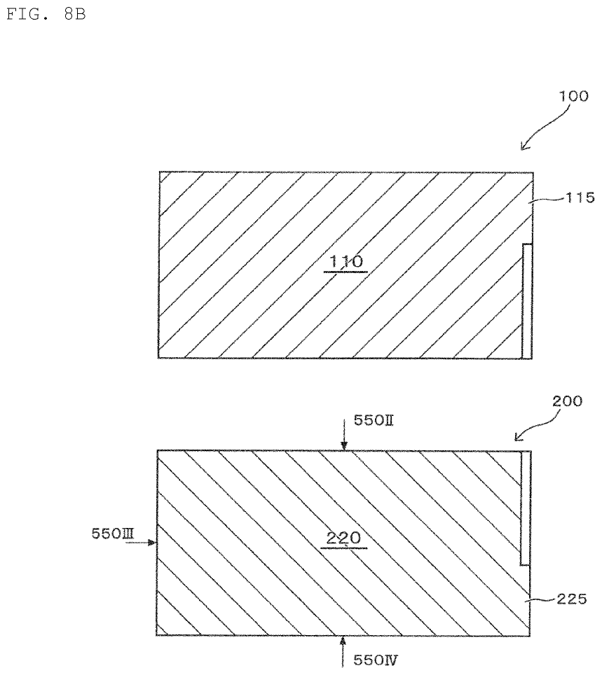

As further focusing on such an effect, it is preferable that the negative electrode active material region is provided to extend to the contour of the solid-state battery laminate in all sides other than a side on which the negative electrode narrowed portion is positioned. This is because it is easy to maximize the battery capacity. That is, in the solid-state battery in which the external terminals on both the positive electrode side and the negative electrode side are positioned on the same surface of the solid-state battery laminate, the battery capacity is likely to be maximized, and therefore, the volume energy density is most likely to be improved. For example, as illustrated in the lower views of FIGS. 8(A) and 8(B), the negative electrode active material region 220 may be provided up to the contour (that is, the outermost peripheral edge) of the solid-state battery laminate corresponding to three non-negative electrode narrowed sides 550II, 550III, and 550IV.

In the embodiment illustrated in FIG. 8(A), in the contour of the solid-state battery laminate corresponding to the non-positive electrode narrowed sides 550II, 550III, and 550IV, the positive electrode active material region 110 is not provided to this contour. On the other hand, the negative electrode active material region 220 is provided to extend to the contour of the solid-state battery laminate in all sides other than a side on which the negative electrode narrowed portion 225 is positioned.

From the viewpoint of maximizing the battery capacity, the embodiment illustrated in FIG. 8(B) is also conceivable. In such an embodiment, the positive electrode active material region 110 is provided to extend to the contour of the solid-state battery laminate in all sides other than a side on which the positive electrode narrowed portion 115 is positioned, and the negative electrode active material region 220 is provided to extend to the contour of the solid-state battery laminate also in all sides other than a side on which the negative electrode narrowed portion 225 is positioned.

In plan view as illustrated in the drawing, the negative electrode active material region and the positive electrode active material region may have different areas. For example, the area of the negative electrode active material region in plan view may be larger than the area of the positive electrode active material region in plan view, and according to this, a disadvantageous phenomenon such as generation of so-called dendrites can be further suppressed. For example, referring to FIG. 3 or 5, the width dimension of the negative portion, which is the non-active material region 270 around the negative electrode narrowed portion 225 in the negative electrode layer 200, may be smaller than the width dimension of the negative portion, which is the non-active material region 170 around the positive electrode narrowed portion 115 in the positive electrode layer 100. This is because such a configuration effectively contributes to a relatively large area of the negative electrode active material region 110 in plan view.

The present invention can be embodied in various embodiments. This will be described below.

(Embodiment of Surface-Mounted Solid-State Battery)

This embodiment is an embodiment in which the solid-state battery is a mountable battery. In particular, the solid-state battery according to this embodiment can be mounted on substrates such as a printed wiring board or a motherboard. For example, the solid-state battery can be surface-mounted on the substrate via an external terminal through solder reflow or the like. In this respect, the solid-state battery of the present invention is a surface-mounted battery, that is, a surface mount device (SMD)-type battery. Due to surface mounting, the solid-state battery has a size that enables the battery to be mounted on the substrate. For example, the solid-state battery may have the same size as other electronic components (for example, active elements and/or passive elements) to be mounted on the substrate. Although being merely an example, at least one side dimension of the solid-state battery laminate having a rectangular parallelepiped shape may be less than 1 cm.

In the SMD-type solid-state battery according to the present invention, the “same plan” preferably corresponds to the mounting-side surface. That is, in the solid-state battery of this embodiment, the surface (for example, the side surface) of the solid-state battery laminate on which the external terminals on both the positive electrode side and the negative electrode side are positioned is the surface most proximal to the substrate in mounting.

Therefore, the solid-state battery of this embodiment can be mounted as illustrated in FIG. 4, and is an SMD-type surface-mounted component in which an adverse effect attributable to expansion due to charging and discharging and/or thermal expansion, and the like is reduced. The expansion of the solid-state battery is likely to occur particularly in a direction along the lamination direction. When the external terminals on the positive electrode side and the negative electrode side are bonded by solder and mounted, the lamination direction of the solid-state battery faces a direction substantially orthogonal to the facing direction between the substrate and the solid-state battery (see FIG. 4). Therefore, if the solid-state battery expands, the solid-state battery does not contact or collide with the substrate, and a failure or the like related to the mounted battery is hardly to occur. As illustrated in FIG. 4, in such an embodiment, the side surface having a smaller area than the largest main surface in the solid-state battery or the solid-state battery laminate may be the “mounting-side surface”. That is, this side surface on which the external terminals are provided may be a surface closest to the substrate as a whole (that is, the closest surface).

(Embodiment of External Terminals Extending Short)

This embodiment is an embodiment in which the external terminals are provided relatively short. In the drawings referred to in the solid-state battery described above, the external terminals are provided to sectionally protrude from the “same surface”. For example, as can be seen with reference to FIG. 1, in the above-described solid-state battery, each of the positive electrode external terminal 400A and the negative electrode external terminal 400B extends to the main surface facing the solid-state battery laminate 500 with a “same surface” 510 interposed therebetween. On the other hand, as illustrated in FIG. 4, in the solid-state battery according to this embodiment, each of the positive electrode external terminal 400A and the negative electrode external terminal 400B is positioned only on the “same surface” 510 and does not extend to surfaces of the solid-state battery laminate 500 other than the same surface. That is, each of the positive electrode external terminal 400A and the negative electrode external terminal 400B is provided on the “same surface” but is not provided to extend to other surfaces continuous to the “same surface”. As illustrated in FIG. 4, each of the positive electrode external terminal 400A and the negative electrode external terminal 400B may terminate at a boundary edge between the “same surface” 510 and the main surface continuous to the same surface (for example, each of both facing main surfaces of the solid-state battery laminate).

In the solid-state battery of this embodiment, the external terminals do not extend long to a portion other than the “same surface”, and this configuration can achieve a reduction in height or size of the solid-state battery as a whole (see the upper view of FIG. 4). As can be seen from the embodiment of the surface-mounted solid-state battery as illustrated in the lower view of FIG. 4, when the solid-state battery in which the external terminals do not extend to the main surface is an SMD-type solid-state battery, the external terminals are positioned only between the substrate and the solid-state battery. Thus, the mounted solid-state battery is less likely to cause undesirable interaction with other electronic components, and a more reliable solid-state battery can be obtained.

(Embodiment Regarding Width Dimensional Relation Between Electrode Narrowed Portions)

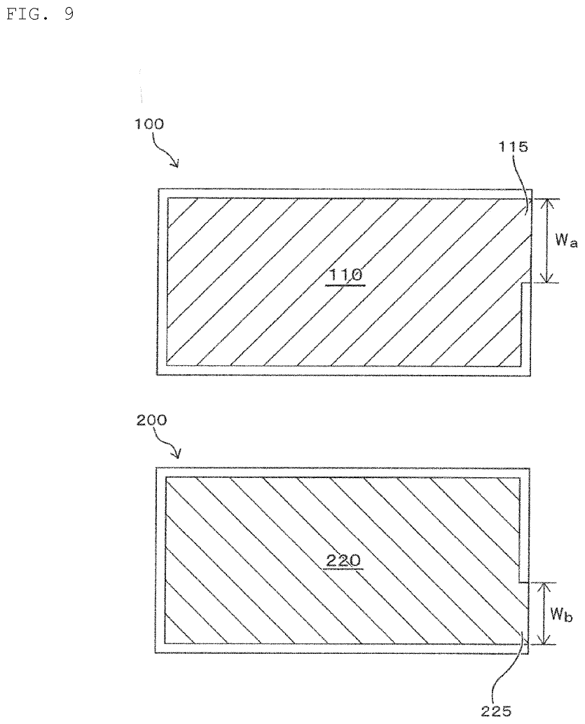

This embodiment has a feature in a relative width dimensional relation between the positive electrode narrowed portion and the negative electrode narrowed portion. Specifically, as illustrated in FIG. 9, the width dimension of the positive electrode narrowed portion 115 is larger than the width dimension of the negative electrode narrowed portion 225. That is, in plan view illustrated in the drawing, when the width dimension of the positive electrode narrowed portion 115 is designated as “Wa” and the width dimension of the negative electrode narrowed portion 225 is designated as “Wb”, Wa>Wb is satisfied.

Such an embodiment of the width dimensional relation between the electrode narrowed portions may be more suitable in terms of the electron conductivity of the electrodes. Specifically, the electron conductivity is lower in the positive electrode layer than in the negative electrode layer in terms of material quality; however, in this case, when the width dimension of the positive electrode narrowed portion is larger than the width dimension of the negative electrode narrowed portion, the electron conductivity of the positive electrode layer is easily improved.

[Method for Manufacturing Solid-State Battery]

The solid-state battery of the present invention can be obtained through a process of producing a solid-state battery laminate having a positive electrode layer, a negative electrode layer, and a solid electrolyte layer between these electrodes.

The solid-state battery laminate can be produced using a printing method such as a screen printing method, a green sheet method using a green sheet, or a composite method thereof. That is, the solid-state battery laminate can be produced according to a common method for manufacturing a solid-state battery. Therefore, as raw materials such as a solid electrolyte, an organic binder, a solvent, an arbitrary additive, a positive electrode active material, and a negative electrode active material which will be described below, those used in a known method for manufacturing a solid-state battery may be adopted.

Hereinafter, for better understanding the present invention, a certain one manufacturing method will be exemplified and described, but the present invention is not limited to this method. Temporal matters such as description order in the following description are merely for explanatory convenience, and are not necessarily limited thereto.

(Laminate Block Formation)

A solid electrolyte, an organic binder, a solvent, and an arbitrary additive are mixed to prepare a slurry. Next, a sheet having a thickness, for example, about 5 μm to 50 μm after firing is obtained from the prepared slurry by sheet molding. This sheet finally forms the solid electrolyte layer in the solid-state battery laminate.

A positive electrode active material, a solid electrolyte, a conduction aid, an organic binder, a solvent, and an arbitrary additive are mixed to produce a positive electrode paste. Similarly, a negative electrode active material, a solid electrolyte, a conduction aid, an organic binder, a solvent, and an arbitrary additive are mixed to produce a negative electrode paste. As the organic binder, the solvent, the additive, and the like used here, those commonly used in the manufacturing of the solid-state battery may be used.

The positive electrode paste is applied to the sheet, and as necessary, a current collecting layer is printed. In particular, a precursor of the positive electrode active material region obtained from the positive electrode paste is preferably formed by printing so that the precursor has a shape having a narrowed portion. It is preferable to obtain a precursor of the “margin portion” of the peripheral edge of the positive electrode layer by applying an insulating paste. Such an embodiment refers to, for example, the lower view of FIG. 5.

Similarly, the negative electrode paste is applied to the sheet, and as necessary, a current collecting layer is printed. In particular, a precursor of the negative electrode active material region obtained from the negative electrode paste is preferably formed by printing so that the precursor has a shape having a narrowed portion. It is preferable to obtain a precursor of the “margin portion” of the peripheral edge of the negative electrode layer by applying an insulating paste. Such an embodiment refers to, for example, the lower view of FIG. 5.

The sheet to which the positive electrode paste is applied (that is, the precursor of the positive electrode layer) and the sheet to which the negative electrode paste is applied (that is, the precursor of the negative electrode layer) are alternately laminated to obtain a laminate. Note that, the outermost layer of the laminate (the uppermost layer and/or the lowermost layer) may be the solid electrolyte layer or an insulating layer, or may be an electrode layer.

In the precursor of the positive electrode layer, the positive electrode paste is preferably provided to extend to one side of the plan-view contour, and the positive electrode paste may be provided, for example, to be narrowed toward this side. For example, the positive electrode paste can be provided as described above, for example, using a printing method. This “one side of the plan-view contour” finally constitutes the “same surface on which both the positive electrode external terminal and the negative electrode external terminal are provided” in the solid-state battery laminate. Similarly, in the precursor of the negative electrode layer, the negative electrode paste is preferably provided to extend to one side of the plan-view contour, and the negative electrode paste may be provided, for example, to be narrowed toward this side. For example, the positive electrode paste can be provided as described above, for example, using a printing method. This “one side of the plan-view contour” also finally constitutes the “same surface on which both the positive electrode external terminal and the negative electrode external terminal are provided” in the solid-state battery laminate. Although a plurality of precursors of the positive electrode layer may be used, in the plurality of precursors of the positive electrode layer, the positive electrode pastes are preferably provided so as to be narrowed with respect to one another toward the same side of the plan-view contour. Similarly, although a plurality of precursors of the negative electrode layer may be used, in the plurality of precursors of the positive electrode layer, the negative electrode pastes are preferably provided so as to be narrowed with respect to one another toward the same side of the plan-view contour. It is preferable that, when the solid-state battery laminate is formed, the narrowed portion on the positive electrode layer side and the narrowed portion on the negative electrode layer have a non-opposing positional relationship in which these narrowed portions do not face each other in the lamination direction.

(Battery Sintered Body Formation)

After the obtained laminate is integrally pressure-bonded, the laminate is subjected to degreasing and firing. Thereby, the sintered solid-state battery laminate is obtained. Note that, as necessary, the sintered solid-state battery laminate may be subjected to a cutting treatment (such a cutting treatment may be performed before degreasing and/or firing, or may be performed after degreasing and/or firing).

(Formation of External Terminal)

The external terminal on the positive electrode side can be formed, for example, by applying a conductive paste to the positive electrode exposed side surface of the sintered laminate. Similarly, the external terminal on the negative electrode side may be formed, for example, by applying a conductive paste to the negative electrode exposed side surface of the sintered laminate. Such an application itself may use a common technique. Alternatively, the external terminal may be provided by disposing a predetermined metal member to be pasted. The main material for such an external terminal may be selected from at least one selected from the group consisting of silver, gold, platinum, aluminum, copper, tin, and nickel. In the obtained laminate, since the narrowed portion on the positive electrode layer side and the narrowed portion on the negative electrode layer are positioned with respect to the same surface, both the positive electrode external terminal and the negative electrode external terminal may be provided on this same surface.

The external terminals on the positive electrode side and the negative electrode side are not limited to be formed after firing the laminate, and may be formed before firing and subjected to simultaneous sintering.

Through the steps as described above, a desired solid-state battery laminate can be finally obtained. The solid-state battery of the present invention may be a solid-state battery laminate itself, but can be obtained by an additional treatment such as forming an additional protective film or the like on the surface of the solid-state battery laminate or enclosing the solid-state battery laminate in an appropriate exterior body as necessary. Such an additional protective film or additional treatment itself may be common.

Although the embodiments of the present invention have been hereinbefore described, they are merely the typical embodiments. It will be readily appreciated by those skilled in the art that the present invention is not limited to the above embodiments, and that various modifications are possible without departing from the scope of the present invention.

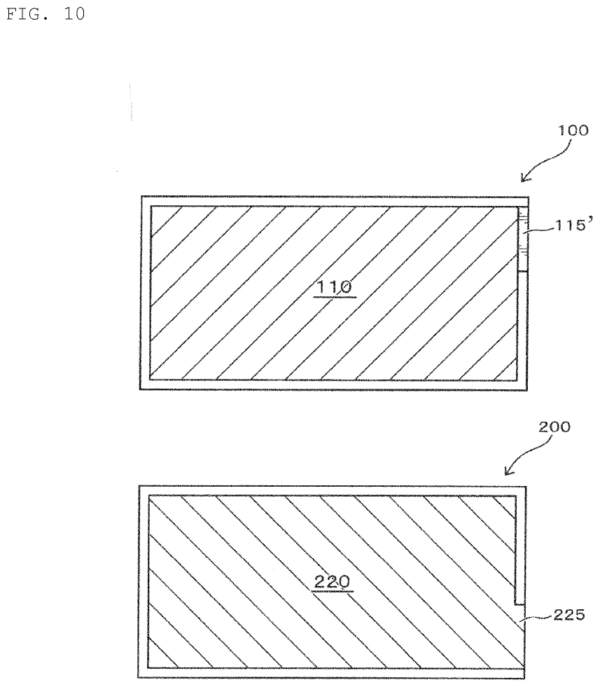

For example, in the drawings referred to in the above description, the embodiment in which the current collecting layer is included in the electrode layer is illustrated, but the present invention is not limited thereto. The current collecting layer may be additionally provided as a layer that contributes to collecting and supplying electrons generated in the active material due to the battery reaction. That is, the positive electrode current collecting layer may be provided with respect to the positive electrode layer, and/or the negative electrode current collecting layer may be provided with respect to the negative electrode layer. For example, while the current collecting layer is not provided on the negative electrode layer, the current collecting layer (that is, the positive electrode current collecting layer) may be provided only on the positive electrode layer. When the current collecting layer is provided as described above, the current collecting layer may form a narrowed portion. For example, when the positive electrode current collecting layer is provided on the positive electrode layer, as illustrated in plan view of FIG. 10, the positive electrode narrowed portion may be formed by adopting an embodiment in which a portion 115′ of the positive electrode current collecting layer protrudes in the “same surface”.

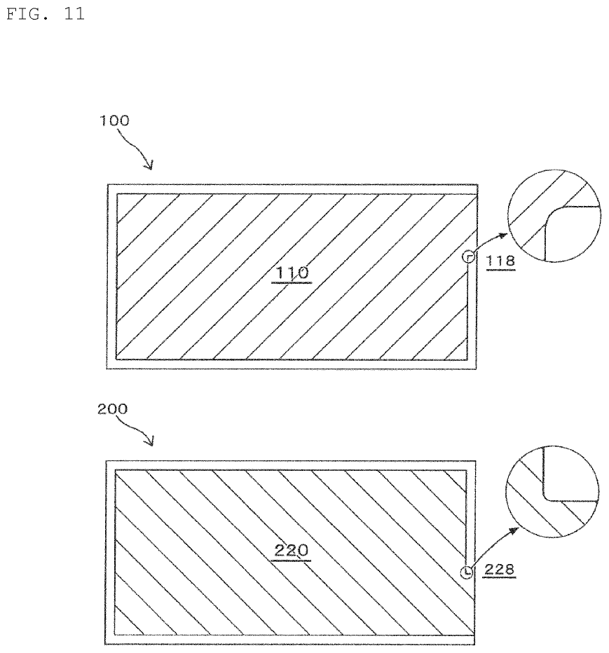

For example, in the drawings referred to in the above description, the electrode narrowed portion has an angular contour, but the present invention is not limited thereto. That is, the contour of the narrowed portion is not limited to a linear shape, and may has a curved shape or may sectionally include such a curved portion. As illustrated in FIG. 11, in plan view, the contour corner of the narrowed portion (118, 228) is rounded or may be rounded. In such a case, it is possible to achieve an effect of enabling undesired stress concentration at the contour corner to be reduced.

The solid-state battery according to the present invention can be used in various fields where battery use or power storage is assumed. Although being merely an example, the solid-state battery of the present invention can be used in the electronics packaging field. The solid-state battery of the present invention can also be used in electric, information, and communication fields using mobile devices and the like (for example, electric and electronic device fields or mobile device fields including mobile phones, smartphones, notebook computers and digital cameras, activity meters, arm computers, electronic paper, wearable devices, and the like, and small-sized electronic devices such as RFID tags, card-type electronic money, and smartwatches), home and small industrial applications (for example, fields of electric tools, golf carts, and home, nursing, and industrial robots), large industrial applications (for example, fields of forklifts, elevators, and harbor cranes), transportation system fields (for example, fields of hybrid vehicles, electric vehicles, buses, trains, power-assisted bicycles, electric two-wheeled vehicles, and the like), power system applications (for example, fields of various types of power generation, road conditioners, smart grids, household power storage systems, and the like), medical applications (fields of medical device such as earphone hearing aids), pharmaceutical applications (fields of dosage management systems and the like), IoT fields, space and deep sea applications (for example, fields of spacecrafts, submersible research vehicles, and the like), and the like.

### DESCRIPTION OF REFERENCE SYMBOLS

100: Positive electrode layer
110: Positive electrode active material region
115: Positive electrode narrowed portion
118: Contour corner of narrowed portion
170: Non-active material region (positive electrode side)
200: Negative electrode layer
220: Negative electrode active material region
225: Negative electrode narrowed portion
228: Contour corner of narrowed portion
270: Non-active material region (negative electrode side)
300: Solid electrolyte layer
400: External terminal
400A: Positive electrode external terminal
400A′: Positive electrode extending portion
400B: Negative electrode external terminal
400B′: Negative electrode extending portion
500: Solid-state battery laminate
510: Same surface
550I: Positive electrode narrowed side/negative electrode narrowed side
550II: Non-positive electrode narrowed side/non-negative electrode narrowed side
550III: Non-positive electrode narrowed side/non-negative electrode narrowed side
550IV: Non-positive electrode narrowed side/non-negative electrode narrowed side
600: Substrate

1. A solid-state battery comprising:
a solid-state battery laminate having a positive electrode layer, a negative electrode layer, and a solid electrolyte layer interposed between the positive electrode layer and the negative electrode layer;
a positive electrode external terminal connected to the positive electrode layer; and
a negative electrode external terminal connected to the negative electrode layer,
wherein both of the positive electrode external terminal and the negative electrode external terminal are on a same surface of the solid-state battery laminate.

2. The solid-state battery according to claim 1, wherein the positive electrode external terminal and the negative electrode external terminal extend in a same direction on the same surface.

3. The solid-state battery according to claim 2, wherein the positive electrode layer has a positive electrode narrowed portion in which a positive electrode active material region is narrowed toward the same surface, and
the negative electrode layer has a negative electrode narrowed portion in which a negative electrode active material region is narrowed toward the same surface.

4. The solid-state battery according to claim 3, wherein the positive electrode active material region extends to a plan-view contour of the solid-state battery laminate in at least one side other than a side on which the positive electrode narrowed portion is positioned among sides forming the plan-view contour.

5. The solid-state battery according to claim 4, wherein the negative electrode active material region extends to a plan-view contour of the solid-state battery laminate in at least one side other than a side on which the negative electrode narrowed portion is positioned among sides forming the plan-view contour.

6. The solid-state battery according to claim 1, wherein the positive electrode layer has a positive electrode narrowed portion in which a positive electrode active material region is narrowed toward the same surface, and
the negative electrode layer has a negative electrode narrowed portion in which a negative electrode active material region is narrowed toward the same surface.

7. The solid-state battery according to claim 6, wherein the positive electrode active material region extends to a plan-view contour of the solid-state battery laminate in at least one side other than a side on which the positive electrode narrowed portion is positioned among sides forming the plan-view contour.

8. The solid-state battery according to claim 7, wherein the negative electrode active material region extends to a plan-view contour of the solid-state battery laminate in at least one side other than a side on which the negative electrode narrowed portion is positioned among sides forming the plan-view contour.

9. The solid-state battery according to claim 6, wherein the negative electrode active material region extends to the plan-view contour in all sides other than a side on which the negative electrode narrowed portion is positioned.

10. The solid-state battery according to claim 3, wherein the negative electrode active material region extends to the plan-view contour in all sides other than a side on which the negative electrode narrowed portion is positioned.

11. The solid-state battery according to claim 1, wherein surfaces of the solid-state battery laminate other than the same surface are not constrained by external terminals of the positive electrode external terminal and the negative electrode external terminal.

12. The solid-state battery according to claim 1, wherein the solid-state battery laminate has a rectangular parallelepiped shape as a whole, and the same surface corresponds to a side surface of the rectangular parallelepiped shape.

13. The solid-state battery according to claim 1, wherein each of the positive electrode external terminal and the negative electrode external terminal are positioned only on the same surface and do not extend to surfaces of the solid-state battery laminate other than the same surface.

14. The solid-state battery according to claim 1, wherein the solid-state battery is a surface-mounted battery, and the same surface corresponds to a mounting-side surface.

15. The solid-state battery according to claim 1, wherein the solid-state battery laminate is made of a sintered body.

16. The solid-state battery according to claim 1, wherein the positive electrode layer and the negative electrode layer are layers capable of occluding and releasing lithium ions.
